(19) United States
(12) Patent Application Publication
(10) Pub. No.: US 2026/0103359 A1
(43) Pub. Date: Apr. 16, 2026

(54) RECORDING APPARATUS, MEDIUM CUTTING METHOD, AND MEDIUM CUTTING APPARATUS

(71) Applicant: SEIKO EPSON CORPORATION, Tokyo (JP)

(72) Inventors: Naoto HAYAKAWA, MATSUMOTO-SHI (JP); Kenichi TANIOKA, MATSUMOTO-SHI (JP)

(21) Appl. No.: 19/353,781

(22) Filed: Oct. 9, 2025

(30) Foreign Application Priority Data
Oct. 10, 2024 (JP) 2024-177730

(51) Int. Cl. B65H 35/00; B41J 11/70; B65H 29/52

(52) U.S. Cl. CPC B65H 35/0086; B41J 11/70; B65H 29/52

(57) ABSTRACT

A recording apparatus including a medium support, a conveyer, a head, a guide, a cutting unit, a frictional support member, and a controller, when the cutting unit cuts the medium, the controller configured to cause the conveyer and the cutting unit to perform a first operation of conveying the medium by a predetermined amount in a conveyance direction to a position where a leading end of the medium travels beyond the frictional support member, conveying the medium in a direction opposite the conveyance direction until a cutting position of the medium reaches the cutting unit, and cutting the medium.

The present application is based on, and claims priority from JP Application Serial Number 2024-177730, filed October 10, 2024, the disclosure of which is hereby incorporated by reference herein in its entirety.

### BACKGROUND

### Technical Field

The present disclosure relates to a recording apparatus, a medium cutting method, and a medium cutting apparatus.

### Related Art

Various recording apparatuses have been used. The various recording apparatuses include a recording apparatus that can record an image on a conveyed medium and includes a cutting unit that cuts a medium on which the image has been recorded while moving in the width direction. For example, JP-A-2004-268226 discloses a printer that can convey a medium and includes a round blade unit that cuts a recorded medium while moving in the width direction.

JP-A-2004-268226 describes a protruding member that is movably incorporated to a guide groove formed in a direction substantially perpendicular to the direction in which a medium on the paper discharge guide is conveyed. JP-A-2004-268226 discloses that a user may manually move the protruding member in accordance with the width of the medium to set the position of the protruding member. JP-A-2004-268226 further describes that the protruding member is in contact with the left end of the medium, so that media having various sizes can each be linearly cut without the cut edge being curved or the sheet being torn off near the end of the cut edge in a configuration in which the medium is cut from the right side of the body of the printer toward the left side of the body.

In a recording apparatus capable of performing recording on a conveyed medium, a frictional support member is provided in some cases to suppress skew conveyance due, for example, to a support error of the medium. For example, JP-A-2014-151976 describes a support slide portion that supports a recording medium as a portion of a medium support, the support slide portion having a higher coefficient of friction with the medium than that with a medium support surface, and serves as a portion along which the recording medium slides when the recording medium is conveyed. JP-A-2014-151976 discloses that the support slide portion includes elastic members that form multiple protrusions arranged at fixed intervals in a direction that intersects with the conveyance direction.

JP-A-2004-268226 and JP-A-2014-151976 are examples of the related art.

However, in a recording apparatus that can perform recording on a conveyed medium and includes a cutting unit that cuts a medium on which the recording has been performed while moving in the width direction, it is difficult in some cases to cut the medium with high precision. For example, in the printer disclosed in JP-A-2004-268226, when a medium is being cut, a cut medium corresponding to a leading end side of the medium in the conveyance direction and a side where the cutting unit starts cutting the medium may hang down due to gravity, and the medium being cut may bend or otherwise deform. When the medium being cut may bend or otherwise deform, there is a concern that the cutting position of the medium, where the cutting is performed by the cutting unit, may deviate from a desired position, or the medium being cut may come into contact with the head of the printer.

It is therefore conceivable to provide a support slide portion or the like that supports the medium while applying friction onto the medium, as disclosed in JP-A-2014-151976. In the configuration described above, however, the leading end of the medium in the conveyance direction may be caught by the support slide portion, and the orientation of the medium being cut may therefore change, so that the medium may bend or otherwise deform. That is, merely providing the printer described in JP-A-2004-268226 with the support slide portion or the like described in JP-A-2014-151976 may cause the cutting position of the medium, where the cutting is performed by the cutting unit, to deviate from a desired position or the medium being cut to come into contact with the head of the printer, so that it is difficult in some cases to cut the medium with high precision or to avoid a trouble at the time of cutting the medium.

### SUMMARY

A recording apparatus according to an aspect of the present disclosure includes: a medium support configured to support a medium; a conveyer configured to convey the medium in a conveyance direction; a head configured to discharge droplets onto the medium supported by the medium support; a guide provided at a position downstream from the medium support and configured to guide the medium having the droplets discharged thereon from the medium support in the conveyance direction; a cutting unit provided at a position downstream from the head and configured to cut the medium conveyed in the conveyance direction while moving in a width direction that intersects with the conveyance direction; a frictional support member provided at the guide, configured with an elastic member, and configured to support the medium by applying friction onto a rear surface of the medium opposite a surface that receives the droplets; and a controller configured to control the conveyer and the cutting unit, wherein when the cutting unit cuts the medium, the controller is configured to cause the conveyer and the cutting unit to perform a first operation of conveying the medium by a predetermined amount in the conveyance direction to a position where a leading end of the medium travels beyond the frictional support member, conveying the medium in a direction opposite the conveyance direction until a cutting position of the medium reaches the cutting unit, and cutting the medium.

A medium cutting method according to another aspect of the present disclosure is a medium cutting method used by a recording apparatus including a medium support configured to support a medium, a conveyer configured to convey the medium in a conveyance direction, a head configured to discharge droplets onto the medium supported by the medium support, a guide provided at a position downstream from the medium support and configured to guide the medium having the droplets discharged thereon from the medium support in the conveyance direction, a cutting unit provided at a position downstream from the head and configured to cut the medium conveyed in the conveyance direction while moving in a width direction that intersects with the conveyance direction, and a frictional support member provided at the guide, configured with an elastic member, and configured to support the medium by applying friction onto a rear surface of the medium opposite a surface that receives the droplets, the method including performing a first operation when the cutting unit cuts the medium, the first operation including a first conveyance step of conveying the medium by a predetermined amount in the conveyance direction to a position where a leading end of the medium travels beyond the frictional support member, a second conveyance step of conveying the medium in a direction opposite the conveyance direction until a cutting position of the medium reaches the cutting unit, and a cutting step of cutting the medium.

A medium cutting apparatus according to another aspect of the present disclosure includes: a medium support configured to support a medium; a conveyer configured to convey the medium in a conveyance direction; a guide provided at a position downstream from the medium support and configured to guide the medium from the medium support in the conveyance direction; a cutting unit provided at a position downstream from the medium support and configured to cut the medium conveyed in the conveyance direction while moving in a width direction that intersects with the conveyance direction; a frictional support member provided at the guide, configured with an elastic member, and configured to support the medium by applying friction onto a rear surface at which the medium is supported; and a controller configured to control the conveyer and the cutting unit, wherein when the cutting unit cuts the medium, the controller is configured to cause the conveyer and the cutting unit to perform a first operation of conveying the medium by a predetermined amount in the conveyance direction to a position where a leading end of the medium travels beyond the frictional support member, conveying the medium in a direction opposite the conveyance direction until a cutting position of the medium reaches the cutting unit, and cutting the medium.

### BRIEF DESCRIPTION OF THE DRAWINGS

FIG. 1 is a perspective view of a recording apparatus according to an embodiment of the present disclosure.

FIG. 2 is a block diagram showing an electrical configuration of the recording apparatus shown in FIG. 1.

FIG. 3 is a perspective view showing a state immediately after cutting a medium starts in the recording apparatus shown in FIG. 1.

FIG. 4 is a perspective view showing a state immediately before cutting a medium end in the recording apparatus shown in FIG. 1.

FIG. 5 is a side cross-sectional view showing a cutting unit in the recording apparatus shown in FIG. 1 and portions around the cutting unit.

FIG. 6 is a perspective view illustrating a problem with a recording apparatus according to Reference Example, and showing a state in which a leading end of a conveyed medium is caught by a frictional support member.

FIG. 7 is a perspective view illustrating the problem with the recording apparatus according to Reference Example, and showing a state in which the cutting position of the medium is moved from the cutting position in the state shown in FIG. 6 to a cutter.

FIG. 8 is a perspective view illustrating the problem with the recording apparatus according to Reference Example, and showing a state in which the cutting unit is moved to cut the medium from the position in the state shown in FIG. 7.

FIG. 9 is a side cross-sectional view showing a state in which the leading end of the conveyed medium is caught by the frictional support member in the recording apparatus shown in FIG. 1.

FIG. 10 is a side cross-sectional view showing a state in which the medium is further conveyed from the state shown in FIG. 9 in the recording apparatus shown in FIG. 1.

FIG. 11 is a side cross-sectional view showing a state in which the medium is further conveyed from the state shown in FIG. 10 to eliminate the state in which the leading end of the medium is caught by the frictional support member in the recording apparatus shown in FIG. 1.

FIG. 12 is a side cross-sectional view showing a state in which the cutting position of the medium is moved from the cutting position in the state shown in FIG. 11 to the cutter by conveying the medium in the direction opposite the conveyance direction in the recording apparatus shown in FIG. 1.

FIG. 13 is a flowchart showing an example of the procedure of cutting a medium by using the recording apparatus shown in FIG. 1.

### DESCRIPTION OF EMBODIMENTS

The present disclosure will first schematically be described.

A recording apparatus according to a first aspect of the present disclosure includes: a medium support configured to support a medium; a conveyer configured to convey the medium in a conveyance direction; a head configured to discharge droplets onto the medium supported by the medium support; a guide provided at a position downstream from the medium support and configured to guide the medium having the droplets discharged thereon from the medium support in the conveyance direction; a cutting unit provided at a position downstream from the head and configured to cut the medium conveyed in the conveyance direction while moving in a width direction that intersects with the conveyance direction; a frictional support member provided at the guide, configured with an elastic member, and configured to support the medium by applying friction onto a rear surface of the medium opposite a surface that receives the droplets; and a controller configured to control the conveyer and the cutting unit, wherein when the cutting unit cuts the medium, the controller is configured to cause the conveyer and the cutting unit to perform a first operation of conveying the medium by a predetermined amount in the conveyance direction to a position where a leading end of the medium travels beyond the frictional support member, conveying the medium in a direction opposite the conveyance direction until a cutting position of the medium reaches the cutting unit, and cutting the medium.

According to the present aspect, when the cutting unit cuts the medium, the medium is temporarily conveyed by the predetermined amount in the conveyance direction to the position where the leading end of the medium travels beyond the frictional support member, the medium is then conveyed in the direction opposite the conveyance direction until the cutting position of the medium reaches the cutting unit, and then the medium is cut. The configuration described above allows cutting the medium while supporting the medium with the frictional support member, and can prevent the cutting operation from being performed in the state in which the leading end of the medium is caught by the frictional support member so that the medium bends. Therefore, the medium can be cut with high precision, and a trouble at the time of cutting the medium can be avoided.

In a recording apparatus according to a second aspect of the present disclosure that is an aspect according to the first aspect, the controller is configured to cause the conveyer and the cutting unit to selectively perform the first operation and a second operation different from the first operation, and the conveyer and the cutting unit to perform the first operation when a length, along the conveyance direction, of a cut medium cut off by the cutting unit falls within a predetermined range.

According to the present aspect, the first operation is performed when the length of the cut medium along the conveyance direction falls within the predetermined range. The present aspect therefore allows suppressing a decrease in throughput due to performing the first operation, and therefore allows suppressing a decrease in productivity when the length of the cut medium along the conveyance direction does not fall within the predetermined range, so that the medium can be cut with high precision and a trouble at the time of cutting the medium can be avoided without performing the first operation.

In a recording apparatus according to a third aspect of the present disclosure that is an aspect according to the second aspect described above, the second operation causes the medium to be conveyed in the conveyance direction until the cutting position of the medium reaches the cutting unit, and causes the medium to be cut without conveying the medium in the direction opposite the conveyance direction, and the controller is configured to cause the conveyer and the cutting unit to perform the second operation when the length of the cut medium along the conveyance direction does not fall within the predetermined range.

According to the present aspect, when the length of the cut medium along the conveyance direction does not fall within the predetermined range, the second operation of conveying the medium in the conveyance direction until the cutting position of the medium reaches the cutting unit and then cutting the medium without conveying the medium in the direction opposite the conveyance direction is performed. Since the second operation can be performed in a shorter period than the first operation, a decrease in throughput due to performing the first operation can be suppressed, and a decrease in productivity can therefore be suppressed when the medium can be cut with high precision and a trouble at the time of cutting the medium can be avoided without performing the first operation.

In a recording apparatus according to a fourth aspect of the present disclosure that is an aspect according to any one of the first to third aspects described above, the frictional support member is configured to support a portion of the rear surface of the medium being cut by the cutting unit by applying friction onto the portion.

According to the present aspect, the frictional support member supports a portion of the rear surface of the medium being cut by the cutting unit while applying friction onto the portion. The configuration described above can preferably reduce the risk that the cut medium on the side where the cutting unit starts cutting the medium hangs down due to gravity when the medium is being cut, so that the medium being cut bends or otherwise deforms.

In a recording apparatus according to a fifth aspect of the present disclosure that is an aspect according to the fourth aspect described above, the cutting unit moves from one side toward another side in the width direction, and the frictional support member is provided on the one side at the guide.

According to the present aspect, the cutting unit moves from the one side toward the other side in the width direction, and the frictional support member is provided on the one side at the guide. The configuration described above can particularly preferably reduce the risk that the cut medium on the side where the cutting unit starts cutting the medium hangs down due to gravity when the medium is being cut, so that the medium being cut bends or otherwise deforms.

A medium cutting method according to a sixth aspect of the present disclosure is a medium cutting method used by a recording apparatus including

a medium support configured to support a medium, a conveyer configured to convey the medium in a conveyance direction, a head configured to discharge droplets onto the medium supported by the medium support, a guide provided at a position downstream from the medium support and configured to guide the medium having the droplets discharged thereon from the medium support in the conveyance direction, a cutting unit provided at a position downstream from the head and configured to cut the medium conveyed in the conveyance direction while moving in a width direction that intersects with the conveyance direction, and a frictional support member provided at the guide, configured with an elastic member, and configured to support the medium by applying friction onto a rear surface of the medium opposite a surface that receives the droplets, the method including performing a first operation when the cutting unit cuts the medium, the first operation including a first conveyance step of conveying the medium by a predetermined amount in the conveyance direction to a position where a leading end of the medium travels beyond the frictional support member, a second conveyance step of conveying the medium in a direction opposite the conveyance direction until a cutting position of the medium reaches the cutting unit, and a cutting step of cutting the medium.

According to the present aspect, when the cutting unit cuts the medium, the medium is temporarily conveyed by the predetermined amount in the conveyance direction to the position where the leading end of the medium travels beyond the frictional support member, the medium is then conveyed in the direction opposite the conveyance direction until the cutting position of the medium reaches the cutting unit, and then the medium is cut. The configuration described above allows cutting the medium while supporting the medium with the frictional support member, and can prevent the cutting operation from being performed in the state in which the leading end of the medium is caught by the frictional support member so that the medium bends. Therefore, the medium can be cut with high precision, and a trouble at the time of cutting the medium can be avoided.

In a medium cutting method according to a seventh aspect of the present disclosure that is an aspect according to the sixth aspect described above, the recording apparatus is configured to selectively perform the first operation and a second operation different from the first operation when the cutting unit cuts the medium, and perform the first operation when a length, along the conveyance direction, of a cut medium cut off by the cutting unit falls within a predetermined range.

According to the present aspect, the first operation is performed when the length of the cut medium along the conveyance direction falls within the predetermined range. The present aspect therefore allows suppressing a decrease in throughput due to performing the first operation, and therefore allows suppressing a decrease in productivity when the length of the cut medium along the conveyance direction does not fall within the predetermined range, so that the medium can be cut with high precision and a trouble at the time of cutting the medium can be avoided without performing the first operation.

In a medium cutting method according to an eighth aspect of the present disclosure that is an aspect according to the seventh aspect described above, the second operation causes the medium to be conveyed in the conveyance direction until the cutting position of the medium reaches the cutting unit, and causes the medium to be cut without conveying the medium in the direction opposite the conveyance direction, and the second operation is performed when the length of the cut medium along the conveyance direction does not fall within the predetermined range.

According to the present aspect, when the length of the cut medium along the conveyance direction does not fall within the predetermined range, the second operation of conveying the medium in the conveyance direction until the cutting position of the medium reaches the cutting unit and then cutting the medium without conveying the medium in the direction opposite the conveyance direction is performed. Since the second operation can be performed in a shorter period than the first operation, a decrease in throughput due to performing the first operation can be suppressed, and a decrease in productivity can therefore be suppressed when the medium can be cut with high precision and a trouble at the time of cutting the medium can be avoided without performing the first operation.

In a medium cutting method according to a ninth aspect of the present disclosure that is an aspect according to any one of the sixth to eighth aspects described above, the frictional support member is configured to support a portion of the rear surface of the medium being cut by the cutting unit by applying friction onto the portion.

According to the present aspect, the frictional support member supports a portion of the rear surface of the medium being cut by the cutting unit while applying friction onto the portion. The configuration described above can preferably reduce the risk that the cut medium on the side where the cutting unit starts cutting the medium hangs down due to gravity when the medium is being cut, so that the medium being cut bends or otherwise deforms.

In a medium cutting method according to a tenth aspect of the present disclosure that is an aspect according to the ninth aspect described above, in the cutting step, the cutting unit is moved from one side toward another side in the width direction, and the frictional support member is provided on the one side at the guide.

According to the present aspect, the cutting unit moves from the one side toward the other side in the width direction, and the frictional support member is provided on the one side at the guide. The configuration described above can particularly preferably reduce the risk that the cut medium on the side where the cutting unit starts cutting the medium hangs down due to gravity when the medium is being cut, so that the medium being cut bends or otherwise deforms.

A medium cutting apparatus according to an eleventh aspect of the present disclosure includes: a medium support configured to support a medium; a conveyer configured to convey the medium in a conveyance direction; a guide provided at a position downstream from the medium support and configured to guide the medium from the medium support in the conveyance direction; a cutting unit provided at a position downstream from the medium support and configured to cut the medium conveyed in the conveyance direction while moving in a width direction that intersects with the conveyance direction; a frictional support member provided at the guide, configured with an elastic member, and configured to support the medium by applying friction onto a rear surface of the medium at which the medium is supported; and a controller configured to control the conveyer and the cutting unit, wherein when the cutting unit cuts the medium, the controller is configured to cause the conveyer and the cutting unit to perform a first operation of conveying the medium by a predetermined amount in the conveyance direction to a position where a leading end of the medium travels beyond the frictional support member, conveying the medium in a direction opposite the conveyance direction until a cutting position of the medium reaches the cutting unit, and cutting the medium.

According to the present aspect, when the cutting unit cuts the medium, the medium is temporarily conveyed by the predetermined amount in the conveyance direction to the position where the leading end of the medium travels beyond the frictional support member, the medium is then conveyed in the direction opposite the conveyance direction until the cutting position of the medium reaches the cutting unit, and then the medium is cut. The configuration described above allows cutting the medium while supporting the medium with the frictional support member, and can prevent the cutting operation from being performed in the state in which the leading end of the medium is caught by the frictional support member so that the medium bends. Therefore, the medium can be cut with high precision, and a trouble at the time of cutting the medium can be avoided.

In a medium cutting apparatus according to a twelfth aspect of the present disclosure that is an aspect according to the eleventh aspect, the controller is configured to cause the conveyer and the cutting unit to selectively perform the first operation and a second operation different from the first operation, and the conveyer and the cutting unit to perform the first operation when a length, along the conveyance direction, of a cut medium cut off by the cutting unit falls within a predetermined range.

According to the present aspect, the first operation is performed when the length of the cut medium along the conveyance direction falls within the predetermined range. The present aspect therefore allows suppressing a decrease in throughput due to performing the first operation, and therefore allows suppressing a decrease in productivity when the length of the cut medium along the conveyance direction does not fall within the predetermined range, so that the medium can be cut with high precision and a trouble at the time of cutting the medium can be avoided without performing the first operation.

In a medium cutting apparatus according to a thirteenth aspect of the present disclosure that is an aspect according to the twelfth aspect described above, the second operation causes the medium to be conveyed in the conveyance direction until the cutting position of the medium reaches the cutting unit, and causes the medium to be cut without conveying the medium in the direction opposite the conveyance direction, and the controller is configured to cause the conveyer and the cutting unit to perform the second operation when the length of the cut medium along the conveyance direction does not fall within the predetermined range.

According to the present aspect, when the length of the cut medium along the conveyance direction does not fall within the predetermined range, the second operation of conveying the medium in the conveyance direction until the cutting position of the medium reaches the cutting unit and then cutting the medium without conveying the medium in the direction opposite the conveyance direction is performed. Since the second operation can be performed in a shorter period than the first operation, a decrease in throughput due to performing the first operation can be suppressed, and a decrease in productivity can therefore be suppressed when the medium can be cut with high precision and a trouble at the time of cutting the medium can be avoided without performing the first operation.

In a medium cutting apparatus according to a fourteenth aspect of the present disclosure that is an aspect according to any one of the eleventh to thirteenth aspects described above, the frictional support member is configured to support a portion of the rear surface of the medium being cut by the cutting unit by applying friction onto the portion.

According to the present aspect, the frictional support member supports a portion of the rear surface of the medium being cut by the cutting unit while applying friction onto the portion. The configuration described above can preferably reduce the risk that the cut medium on the side where the cutting unit starts cutting the medium hangs down due to gravity when the medium is being cut, so that the medium being cut bends or otherwise deforms.

In a medium cutting apparatus according to a fifteenth aspect of the present disclosure that is an aspect according to the fourteenth aspect described above, the cutting unit moves from one side toward another side in the width direction, and the frictional support member is provided on the one side at the guide.

According to the present aspect, the cutting unit moves from the one side toward the other side in the width direction, and the frictional support member is provided on the one side at the guide. The configuration described above can particularly preferably reduce the risk that the cut medium on the side where the cutting unit starts cutting the medium hangs down due to gravity when the medium is being cut, so that the medium being cut bends or otherwise deforms.

A recording apparatus 1 according to an embodiment, which is a recording apparatus and is also a medium cutting apparatus according to an aspect of the present disclosure, will be described below with reference to the drawings. In the drawings, an X-axis direction is the horizontal direction and is a width direction of the recording apparatus 1, a Y-axis direction is the horizontal direction, is a frontward-rearward direction of the recording apparatus 1, and is a direction perpendicular to the X-axis direction, and a Z-axis direction is the vertical direction. It is assumed in the following description that the side at which an arrow points corresponds to a positive (+) direction, and that the side opposite the side at which the arrow points correspond to a negative (−) direction. For example, the vertically upward direction is referred to as a +Z direction, the vertically downward direction is referred to as a −Z direction, the forward direction with respect to the recording apparatus 1 is referred to as a +Y direction, and the rearward direction with respect to the recording apparatus 1 is referred to as a −Y direction.

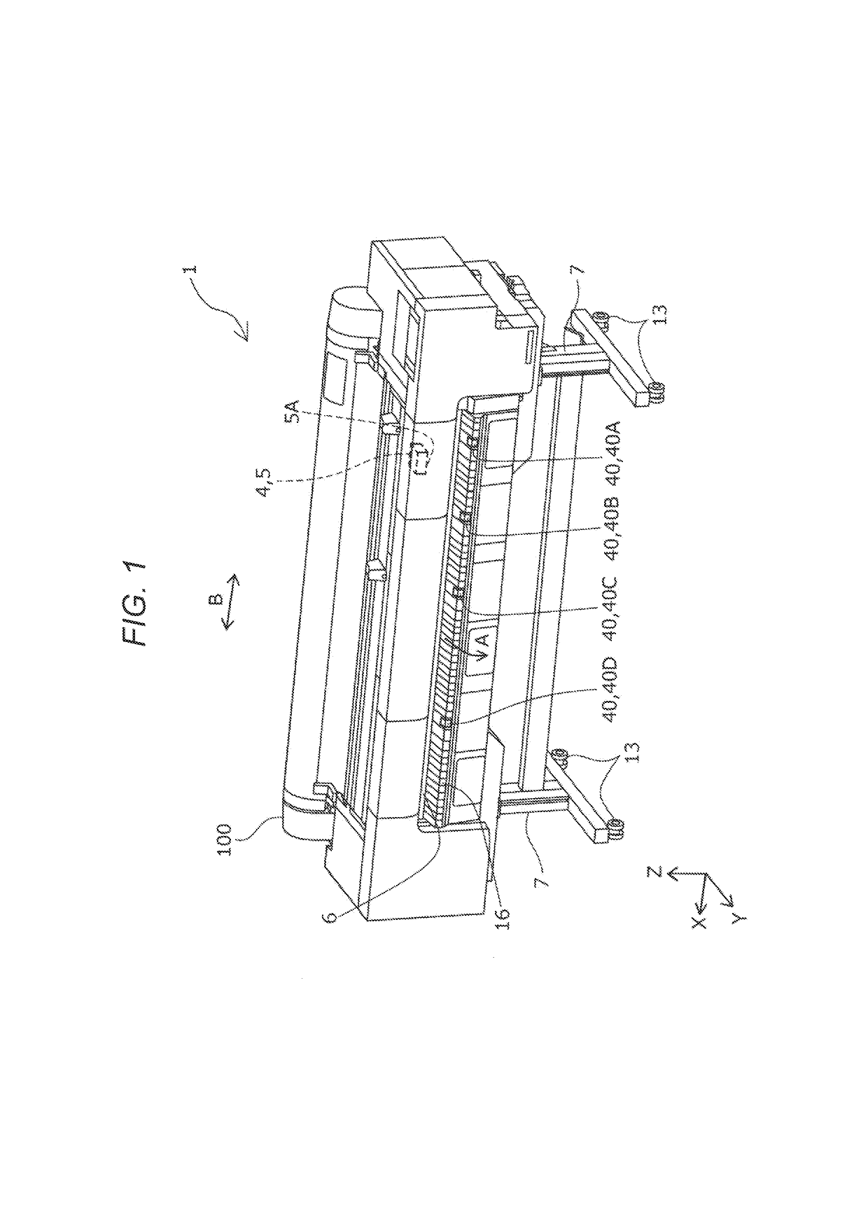

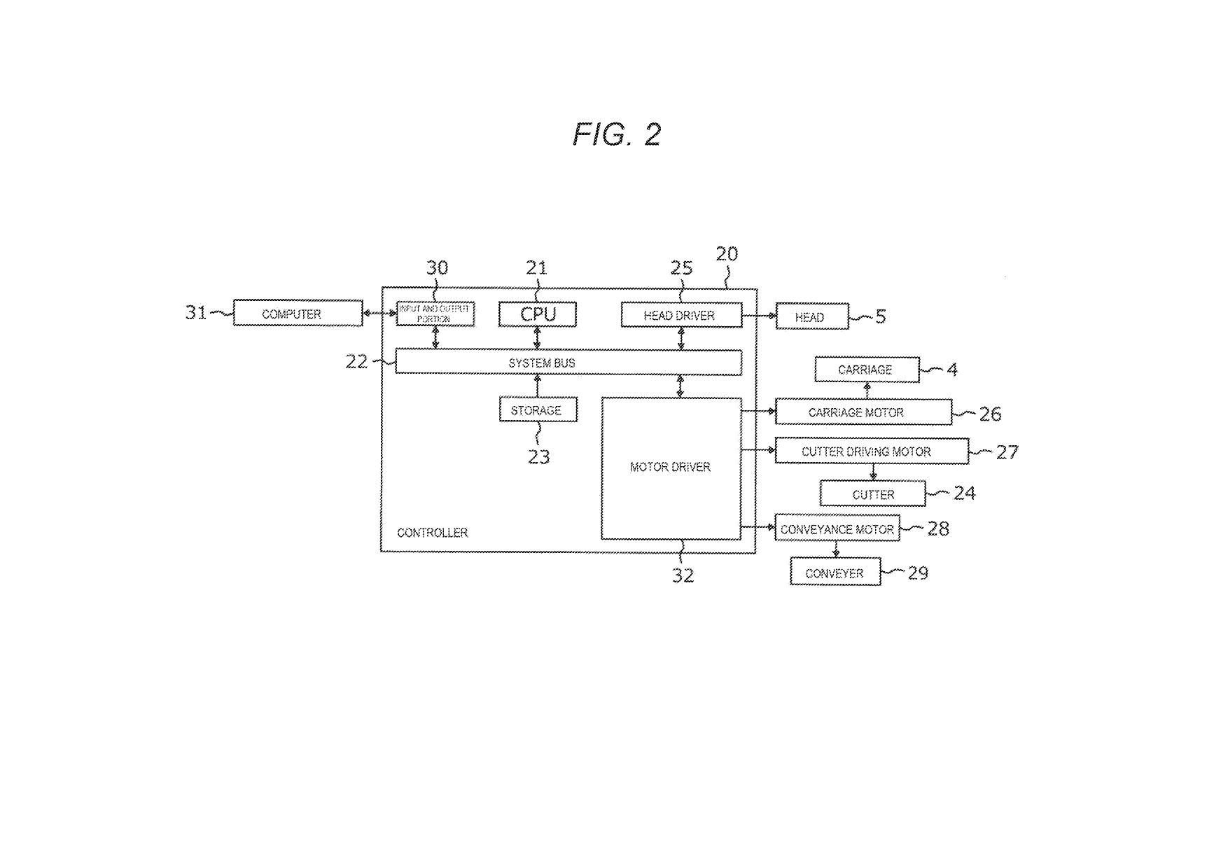

The recording apparatus 1 according to the present embodiment includes an enclosure 100, and leg frames 7 are attached to portions near the opposite ends of the enclosure 100 in the X-axis direction, as shown in FIG. 1. Casters 13 are provided below the leg frames 7, so that the recording apparatus 1 can be readily moved with the aid of the casters 13. The recording apparatus 1 according to the present embodiment further includes a medium supplier that is not shown but holds a medium M wound in the shape of a roll inside the enclosure 100. The medium supplier cooperates with a conveyer 29 shown in FIG. 2 to supply the medium M to a position where the medium M faces an ink discharge surface 5A of a head 5. Although not shown in FIG. 1 or other figures, note that the conveyer 29 in the present embodiment is a pair of conveyance rollers that nip and convey the medium M. The configuration of the conveyer 29 is, however, not limited to a specific configuration.

The recording apparatus 1 according to the present embodiment includes the head 5, which is provided with multiple nozzles at the ink discharge surface 5A and discharges liquid ink in the form of droplets from the nozzles to form an image, and a carriage 4, which incorporates the head 5 and can make reciprocating motion in a width direction B. That is, the width direction B corresponds to the direction in which the carriage 4 scans the medium M. A liquid supply path that is not shown but is configured with a tube or the like is coupled to the head 5, and the ink is supplied to the head 5 via the liquid supply path from multiple ink cartridges loaded into an ink cartridge loaded portion that is not shown. Note in the recording apparatus 1 according to the present example that a conveyance direction A, in which the medium M is conveyed at a position where the medium M faces the ink discharge surface 5A, is the +Y direction, the moving direction of the head 5, that is, the width direction B, which is the direction in which the carriage 4 scans the medium M, is the direction along the X-axis direction, and the direction in which the ink is discharged is the −Z direction.

The configuration described above allows the head 5 to discharge the liquid ink from the nozzles that are not shown onto the conveyed medium M while making reciprocating motion in the width direction B, which is a direction that intersects with the conveyance direction A of the medium M, to form an image. The recording apparatus 1 according to the present embodiment can form a desired image on the medium M by performing recording while performing intermittent conveyance that repeats conveying the medium M by a predetermined amount of conveyance and discharging the ink while moving the head 5 in the width direction B in a state in which the medium M is stationary. The recording apparatus 1, however, does not necessarily have the configuration described above, and may have a configuration including what is called a line head in which nozzles that discharge the ink are arranged along the width direction B across the entire width of the medium M. Furthermore, the recording apparatus 1 may include a head different from an inkjet head that discharges ink in the form of droplets, such as a thermal transfer head.

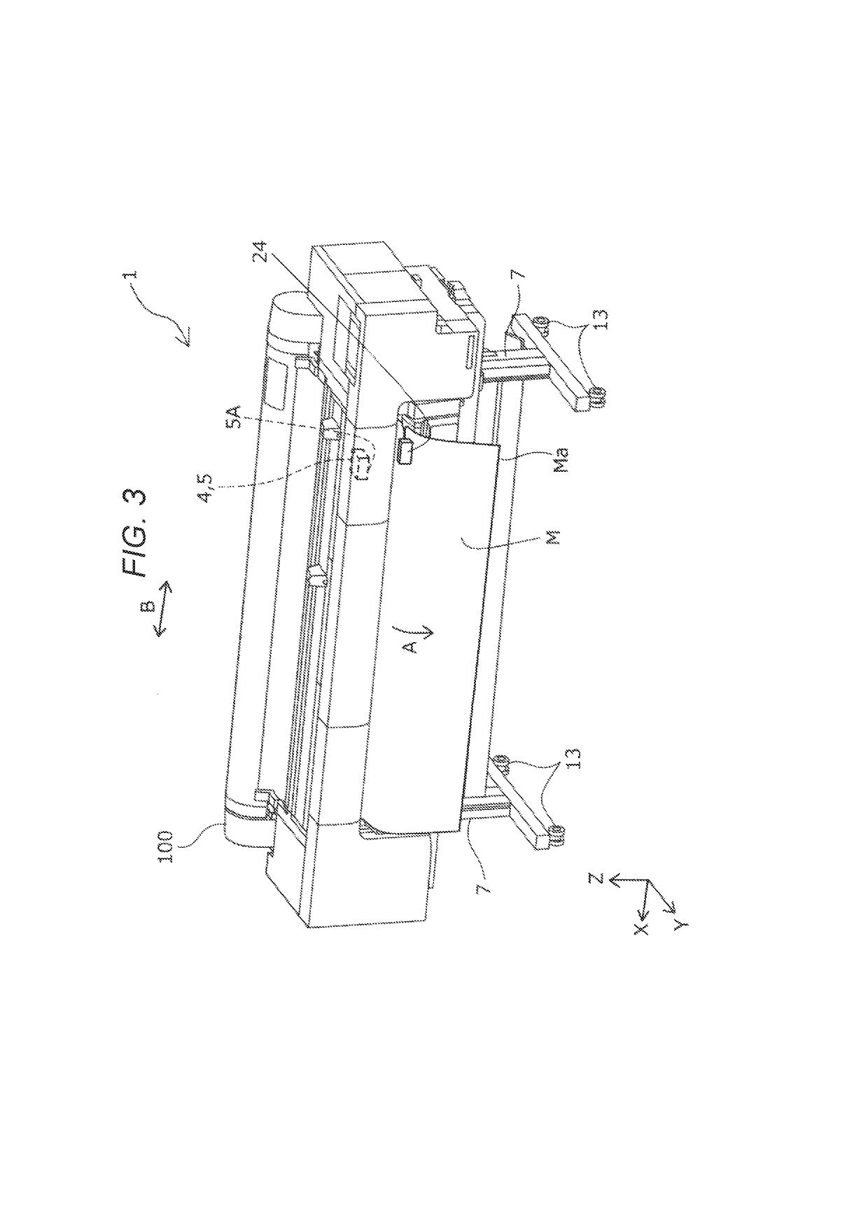

In the recording apparatus 1 according to the present embodiment, the medium M is conveyed from the medium supplier with the medium M supported by a medium support 6. A guide 16, which guides the medium M having ink droplets discharged thereon from the medium support 6 in the conveyance direction A, is provided at a position downstream from the medium support 6. Note in the recording apparatus 1 according to the present embodiment that the medium support 6 and the guide 16, which cooperatively support the medium M conveyed in the conveyance direction A, are provided as separate constituent members, and may instead be integrated with each other into a single constituent member. A cutter 24, which serves as a cutting unit capable of cutting the medium M conveyed in the conveyance direction A while moving in the width direction B, is further provided at a position downstream from the head 5 in the conveyance direction, as shown in FIGS. 3 to 5 and other figures.

The guide 16 is provided with a frictional support member 40 configured with elastic members that support the medium M while applying friction onto the rear surface of the medium M, which is the surface opposite the surface having received the droplets, as shown in FIG. 1 and other figures. The frictional support member 40 can suppress positional displacement or deformation of the medium M due to gravity.

An electrical configuration of the recording apparatus 1 according to the present embodiment will next be described. FIG. 2 is a block diagram of the recording apparatus 1 according to the present embodiment. A controller 20 is provided with a CPU 21 responsible for the overall control of the recording apparatus 1. The CPU 21 is connected via a system bus 22 to a storage 23 including a ROM that stores various control programs and the like executed by the CPU 21 and a RAM that can temporarily store data. The CPU 21 is further coupled to a head driver 25, which drives the head 5, via the system bus 22.

The CPU 21 is further coupled to a motor driver 32, which drives a carriage motor 26, a cutter driving motor 27, and a conveyance motor 28, via the system bus 22. The carriage motor 26 is a motor that moves the carriage 4, in which the head 5 is incorporated. The cutter driving motor 27 is a motor that moves the cutter 24 in the width direction B. The conveyance motor 28 is a motor that drives the conveyer 29 to move the medium M in the conveyance direction A and the direction opposite the conveyance direction A.

The CPU 21 is further coupled to the head driver 25, which drives the head 5 to cause the head 5 to discharge the ink, via the system bus 22. The CPU 21 is further coupled to an external computer 31 or the like, from which recording data or the like is input, and to an input and output portion 30, via which data and signals are transmitted and received.

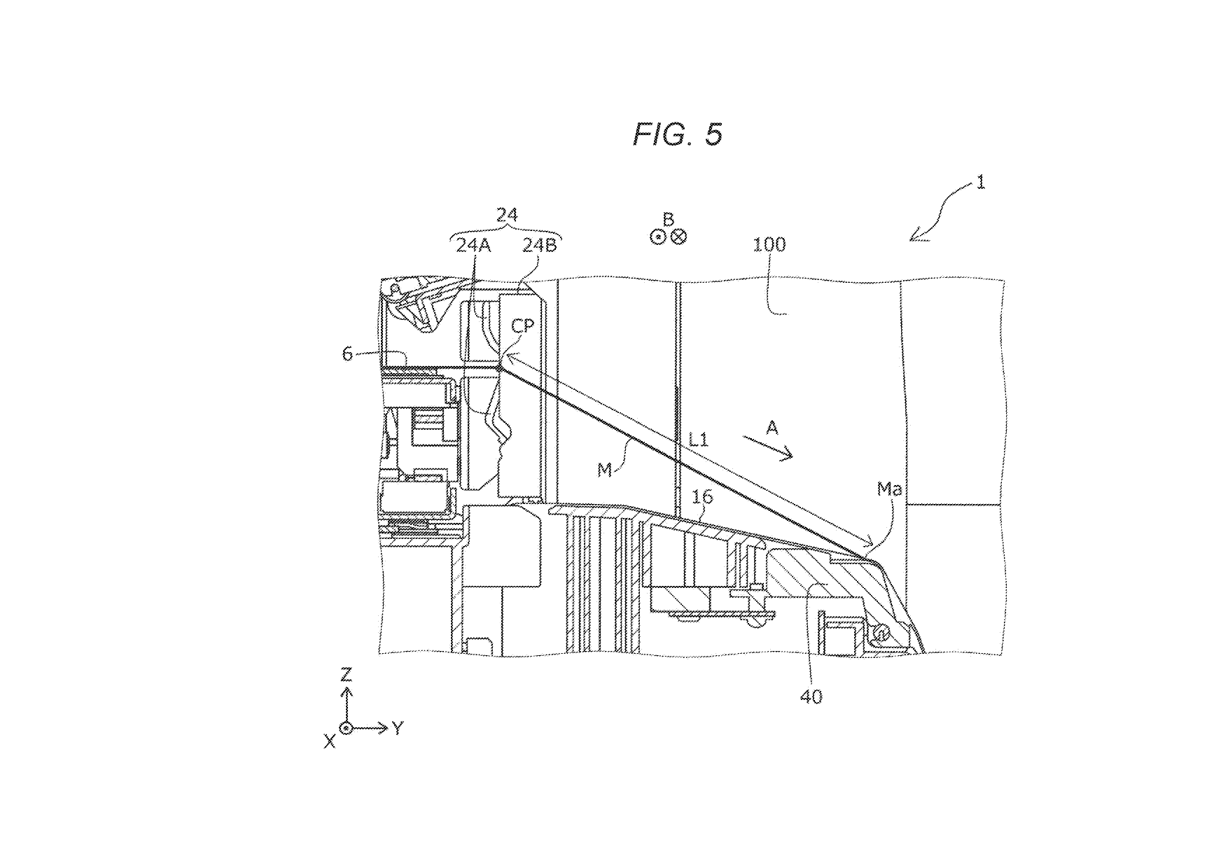

In the recording apparatus 1 according to the present embodiment, the controller 20 can control the conveyance motor 28 and the cutter driving motor 27 to cause the conveyer 29, the cutter 24, and the like to perform a first operation that allows cutting the medium M with high precision and avoiding a trouble at the time of cutting the medium. Specifically, when the medium M is cut with the cutter 24, the controller 20 can, as the first operation, temporarily convey the medium M by a predetermined amount in the conveyance direction A to a position where the leading end of the medium M travels beyond the frictional support member 40, then convey the medium M in the direction opposite the conveyance direction A until the cutting position of the medium M reaches a cutting position CP shown in FIG. 5, where the cutting is performed by the cutter 24, and then cut the medium M with the cutter 24.

Performing the first operation described above allows cutting the medium M while supporting the medium M with the frictional support member 40, and can prevent the cutting operation from being performed in a state in which a leading end Ma of the medium M is caught by the frictional support member 40 so that the medium M bends and curves. Performing the first operation, therefore allows cutting the medium M with high precision while suppressing positional deviation and other errors of the medium M. In addition, when the cutting operation is performed in the state in which the medium M bends and curves, the medium M may curve on the medium support 6, so that the ink discharge position may be shifted, the medium M may come into contact with the head 5, or the medium M may be stuck when the cutter 24 is moved. Such troubles at the time of cutting can be avoided. Furthermore, performing only the conveyance control of the medium M eliminates the need to separately provide a driving mechanism that, for example, retracts the frictional support member 40 in the normal operation and move the frictional support member 40 to the position where the medium M is supported only when it is necessary to do so. The configuration in the present embodiment therefore leads to space saving and cost saving.

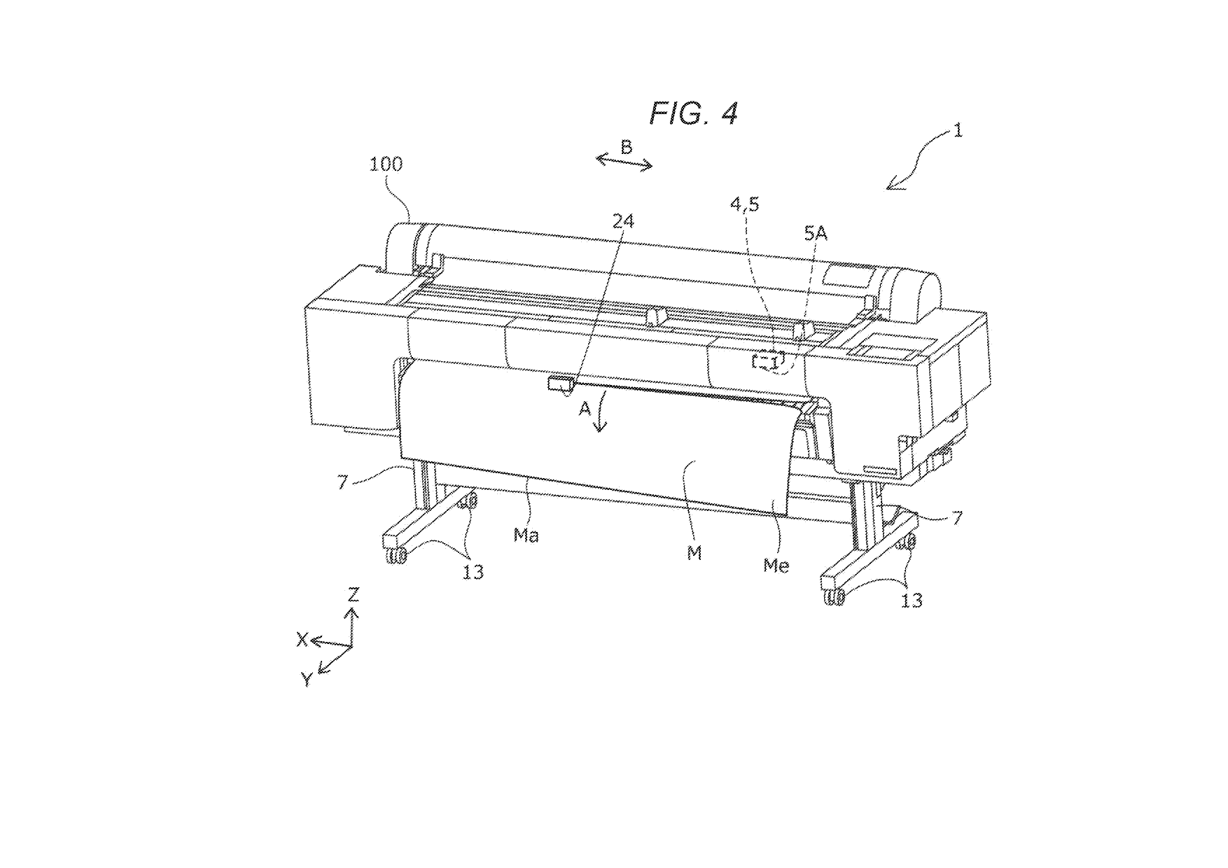

When the medium M is cut, the recording apparatus 1 according to the present embodiment moves the medium M along the conveyance direction A until the cutting position of the medium M reaches the cutting position CP, where the cutting is performed by the cutter 24, as shown in FIG. 3. The cutter 24 is then moved in the +X direction along the width direction B, and the medium M is so cut that the cutting is performed linearly along the width direction B, as shown in FIG. 4.

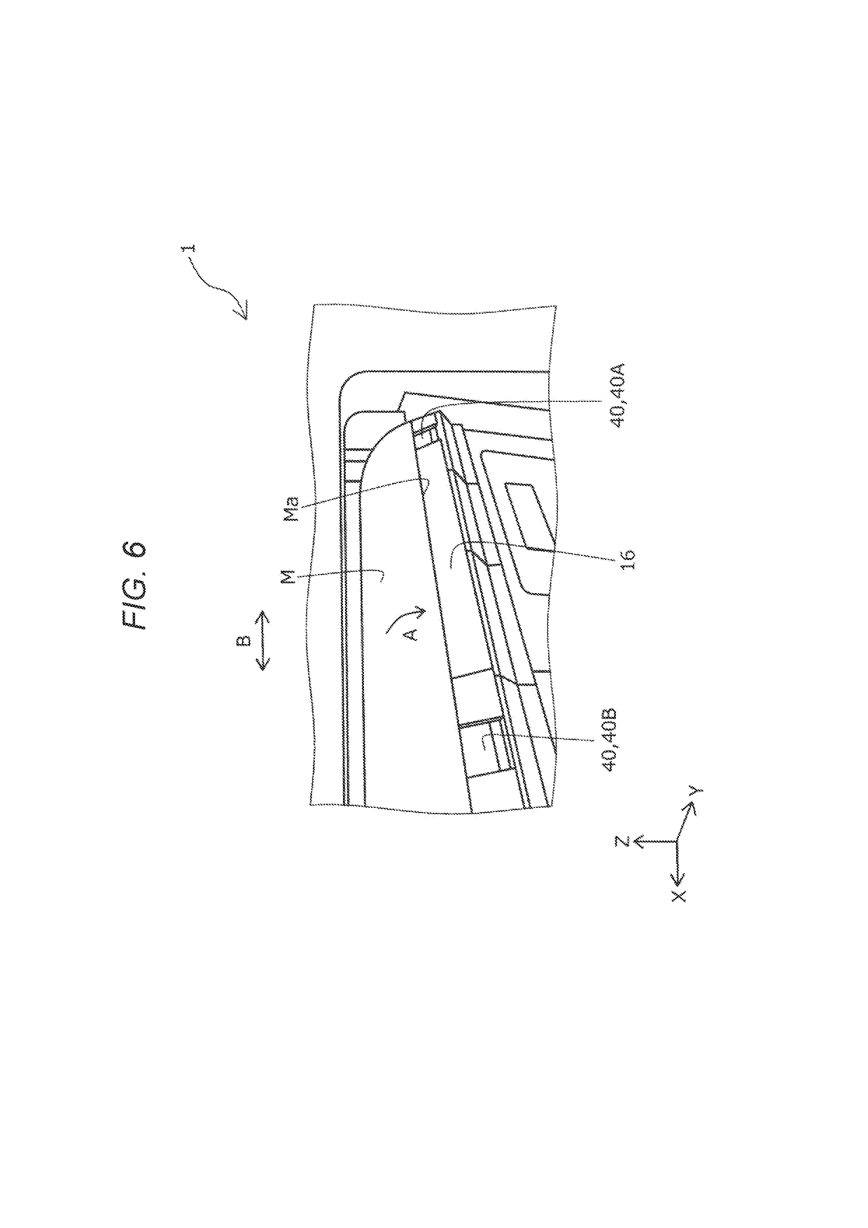

A trouble at the time of cutting, which is a problem with the recording apparatus according to Reference Example shown in FIGS. 6 to 8, which cannot perform the first operation, will be described with reference to FIGS. 5 andFIGS. 6 to 8. Note that FIG. 5 is a side cross-sectional view showing the cutter 24 in the recording apparatus 1 according to the present embodiment and portions around the cutter 24, and that the configuration of the cutter 24 in the recording apparatus according to Reference Example shown in FIGS. 6 to 8 is the same as that in the recording apparatus 1 according to the present embodiment.

FIG. 6 is a perspective view showing a state immediately after the leading end Ma of the medium M on which an image has been recorded by the head 5 and which has been conveyed comes into contact with the frictional support member 40, that is, a state in which the leading end Ma is caught by the frictional support member 40. In this state, the medium M has not bent or otherwise deformed. Note that when the medium M is cut, the frictional support member 40 is intended to support a cut medium Me with a frictional force, the cut medium Me corresponding to a portion of the medium M to be cut off that faces the leading end Ma in the conveyance direction A and is being cut.

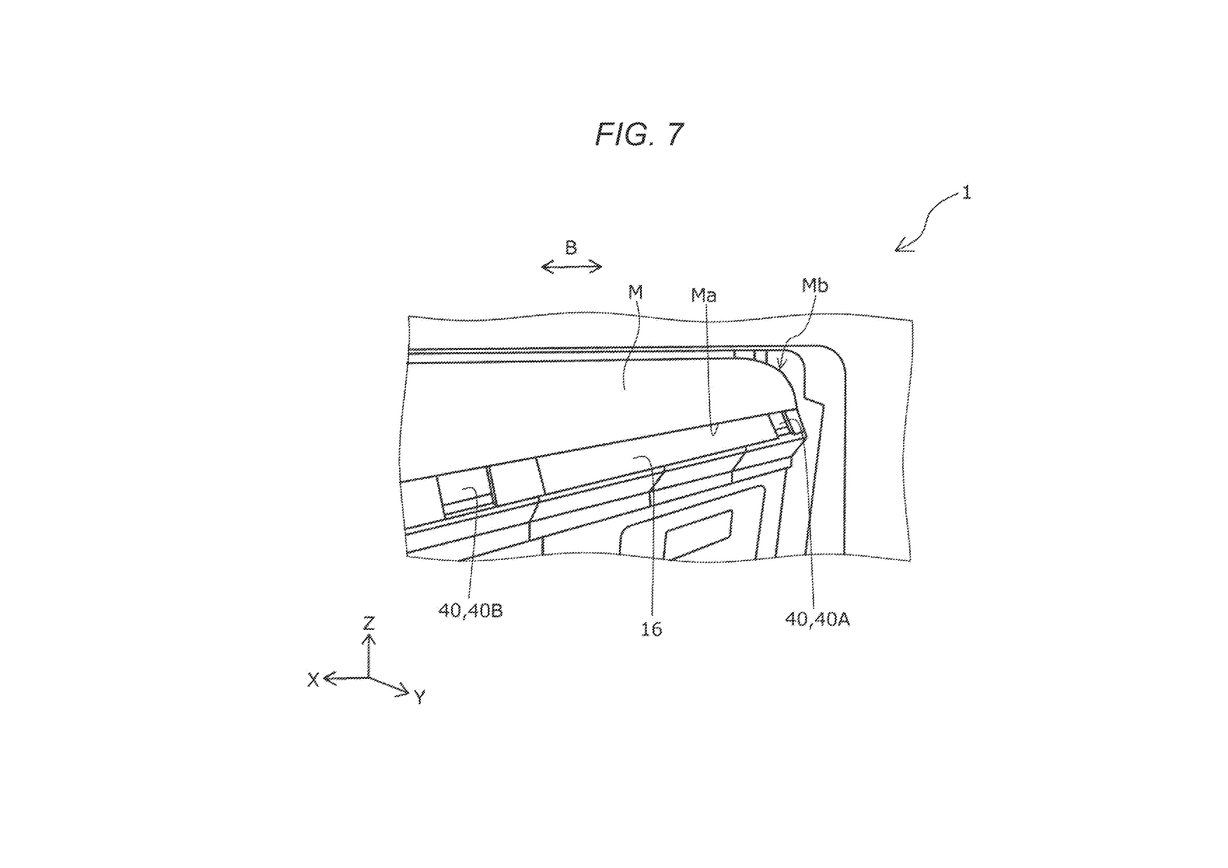

FIG. 7 is a perspective view showing a state in which the medium M is conveyed from the position in the state shown in FIG. 6 to the cutting position CP of the medium M, where the cutting is performed by the cutter 24. FIG. 7 shows a state in which the medium M has a curve Mb after the medium M is further conveyed in the conveyance direction with the state in which the leading end Ma is caught by the frictional support member 40 maintained. When the medium M has the curve Mb, a desired position (cutting position) at which the medium M is to be cut deviates from the cutting position CP, where the cutting is performed by the cutter 24, in the Y-axis and Z-axis directions.

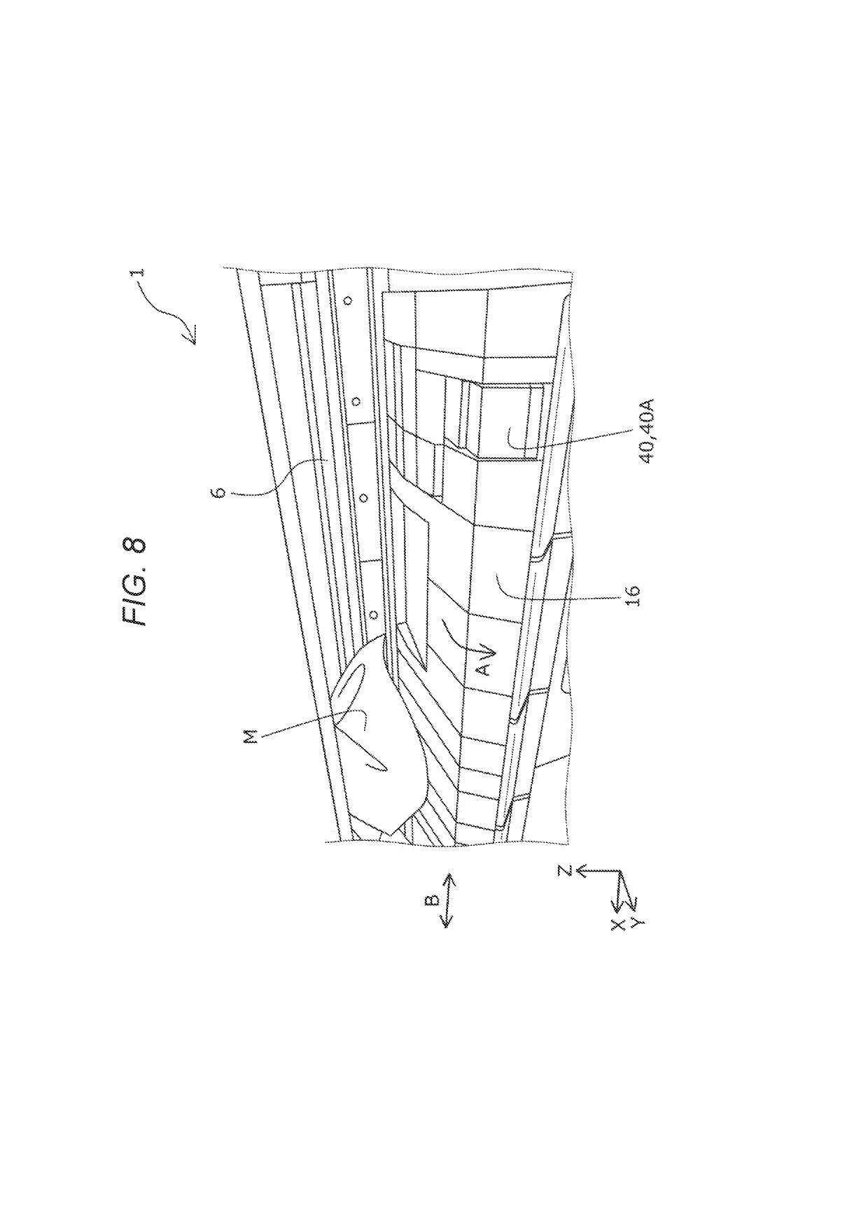

FIG. 8 is a perspective view showing a state in which the cutter 24 is moved along the width direction B to cut the medium M from the position in the state shown in FIG. 7. The cutter 24 includes a blade 24A, which comes into contact with the medium M when the medium M is cut, and a housing 24B, which supports the blade 24A, as shown in FIG. 5. FIG. 8 shows a state in which the medium M is stuck because the medium M comes into contact with the housing 24B, which is a portion of the cutter 24 excluding the blade 24A.

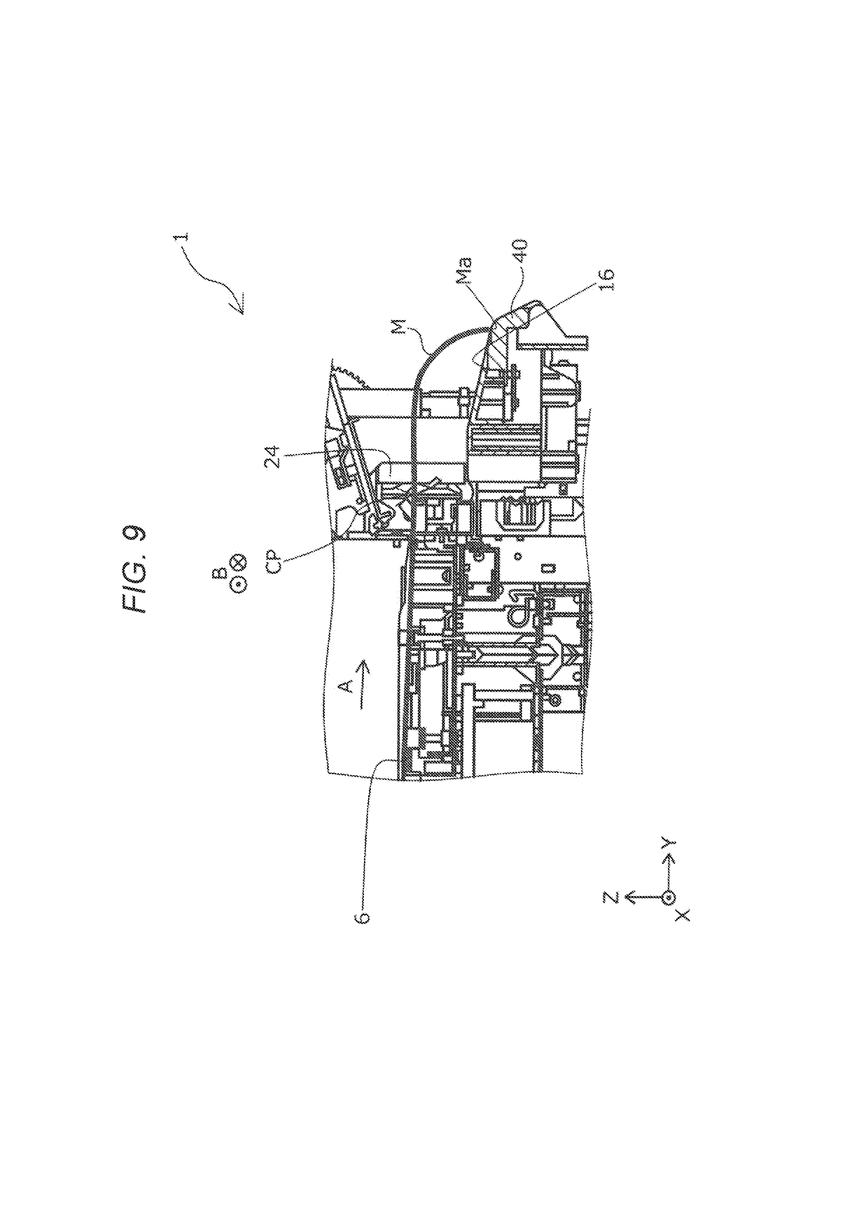

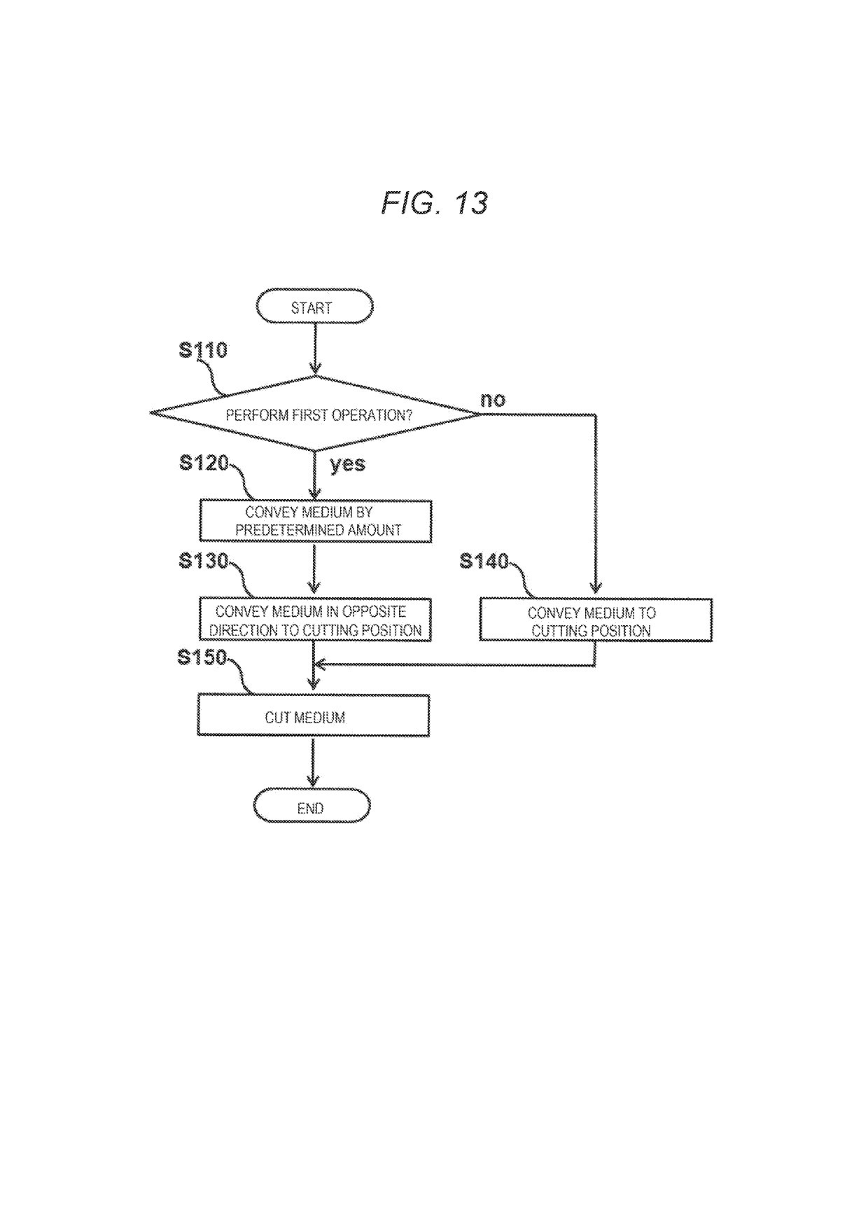

On the other hand, the recording apparatus 1 according to the present embodiment is configured to be able to avoid such a trouble at the time of cutting, as described above. An example of a medium cutting method using the recording apparatus 1 according to the present embodiment will be described below with reference to FIGS. 9 to 12 and with the aid of the flowchart shown in FIG. 13. The medium cutting method according to the present embodiment is executed, for example, at the time of recording a nozzle check pattern used to check whether the ink is discharged from the nozzles of the head 5, from which the ink is discharged, or an adjustment pattern used to adjust the amount of conveyance per conveyance operation accompanying the intermittent conveyance of the medium M. Note, however, that the medium cutting method may also be employed at the time of normal image recording.

When the medium cutting method according to the present embodiment starts, first, in step S110, the controller 20 determines whether to perform the first operation described above. The determination as to whether to perform the first operation may be automatically made by the controller 20 based, for example, on the type of the medium M to be used, the length or area of the cut medium Me in the conveyance direction A resulting from the operation of cutting the medium M, a recording mode, or any other factor, or may be made based on an instruction or the like from a user input via the external computer 31 or the like and the input and output portion 30.

When the controller 20 determines in step S110 to perform the first operation, the controller 20 proceeds to step S120. On the other hand, when the controller 20 determines in step S110 not to perform the first operation, the controller 20 proceeds to step S140. In step S120, the medium M is conveyed by a predetermined amount. The predetermined amount in this operation is a distance that causes the medium M to travel to a position beyond the position where the leading end Ma of the medium M is caught by the frictional support member 40, and eliminates the state in which the leading end Ma of the medium M is caught by the frictional support member 40.

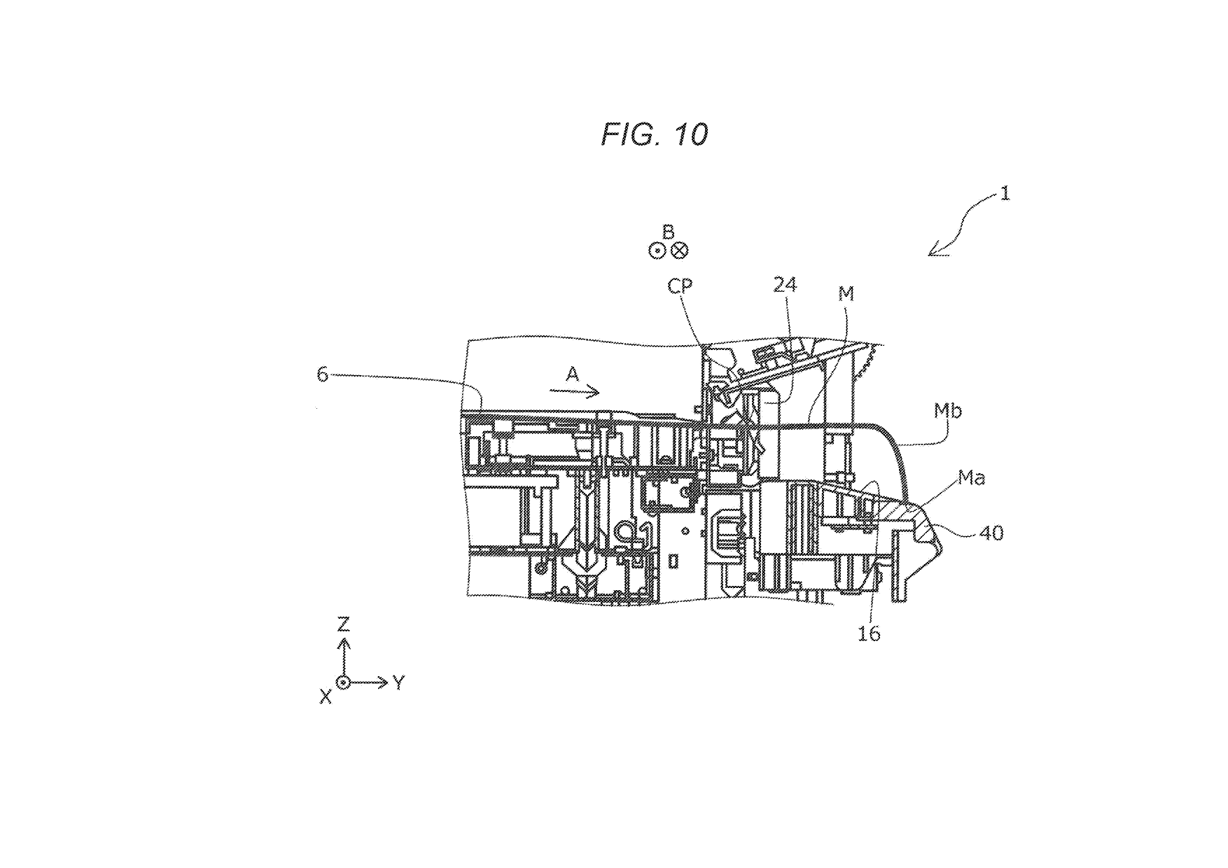

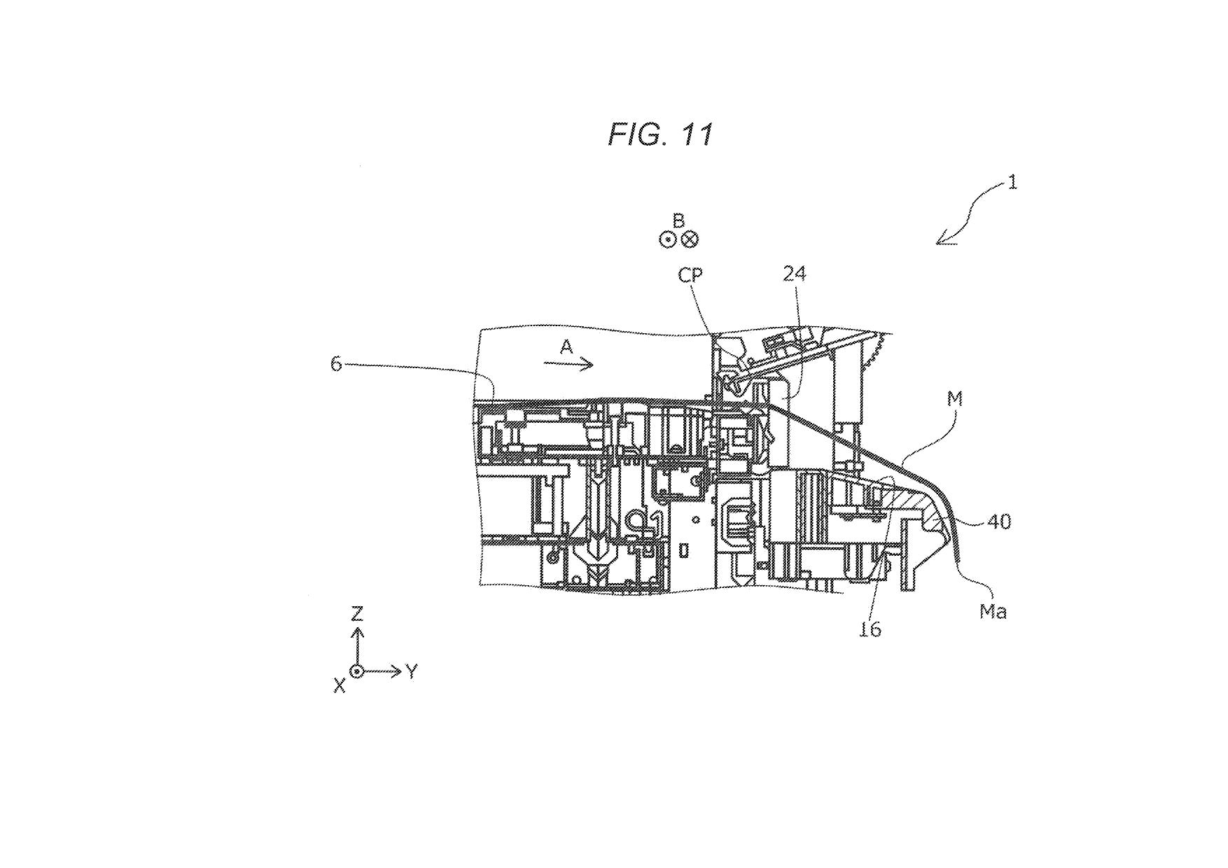

FIG. 9 shows a state immediately after the leading end Ma of the medium M is caught by the frictional support member 40. FIG. 10 shows a state in which the state in which the leading end Ma of the medium M is caught by the frictional support member 40 is maintained even when the medium M is further conveyed in the conveyance direction A from the state shown in FIG. 9. FIG. 11 shows that the state in which the leading end Ma of the medium M is caught by the frictional support member 40 is eliminated. In step S120, the medium M is conveyed in the conveyance direction A until the state shown in FIG. 11 is achieved.

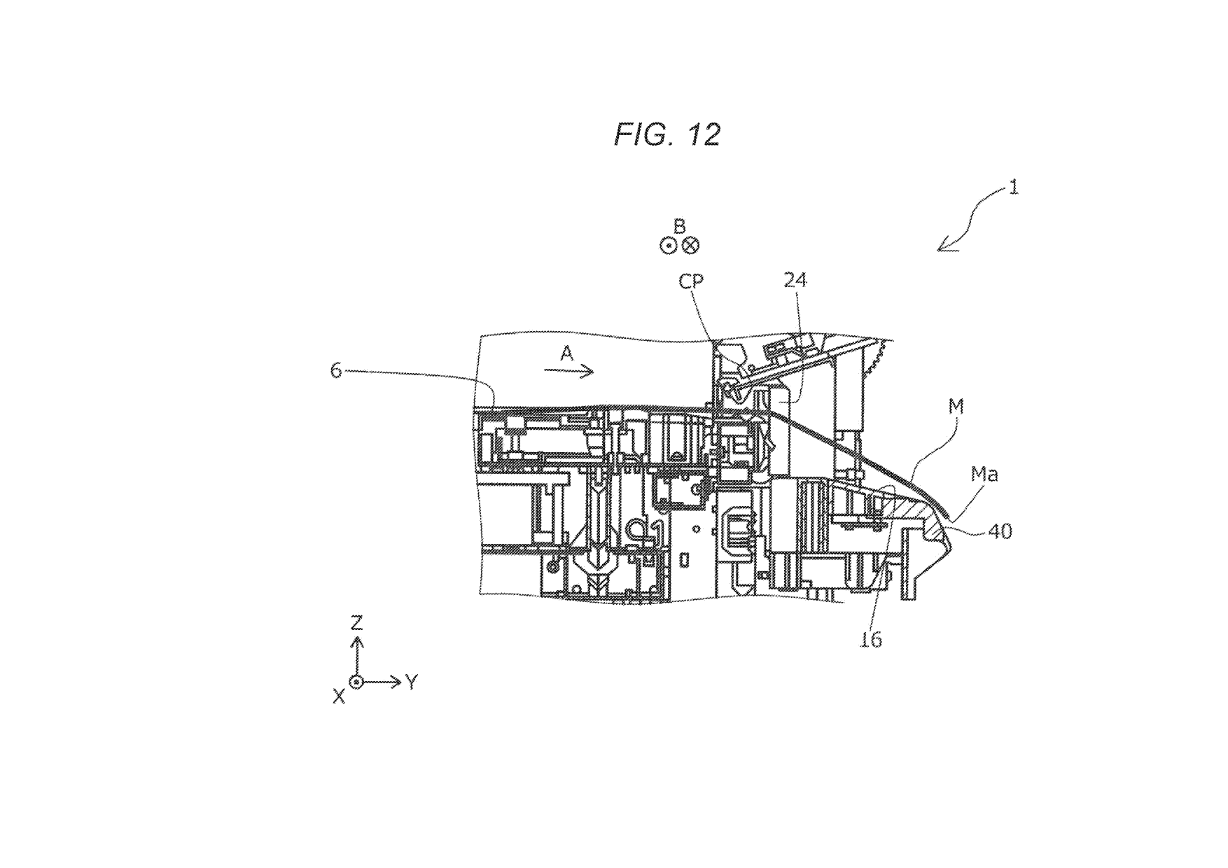

In step S130 after step S120 ends, the medium M is moved in the direction opposite the conveyance direction A until a preferable cutting position of the medium M coincides with the cutting position CP, where the cutting is performed by the cutter 24. FIG. 12 shows a state in which the medium M is moved in the direction opposite the conveyance direction A from the state shown in FIG. 11 and the desired cutting position of the medium M coincides with the cutting position CP, where the cutting is performed by the cutter 24. Causing the desired cutting position of the medium M to coincide with the cutting position CP, where the cutting is performed by the cutter 24, as described above prevents the medium M from bending or otherwise deforming, as shown in FIG. 12.

In step S150 after step S130 ends, the cutter 24 is moved in the width direction B to cut the medium M. Note that when the controller 20 determines in step S110 not to perform the first operation, the method proceeds to step S140, and in step S140, the medium M is moved in the conveyance direction A until the preferable cutting position of the medium M coincides with the cutting position CP, where the cutting is performed by the cutter 24.

The procedure proceeding to step S140 corresponds to a second operation. The second operation can be employed when a trouble at the time of cutting is unlikely to occur even when the first operation is not performed based, for example, on the type of the medium M to be used, the length or area of the cut medium Me in the conveyance direction A resulting from the operation of cutting of the medium M, the recording mode, or any other factor. Since the recording apparatus is driven in a simpler manner in the second operation than in the first operation, the operation period of the second operation can be shorter than that of the first operation.

After step S140 ends, the controller 20 proceeds to step S150. Thereafter, in step S150, the cutter 24 is moved in the width direction B to cut the medium M, as in the first operation. Upon completion of step S150, the medium cutting method according to the present embodiment is completed.

As described above, the medium cutting method, in which the first operation is performed, can be executed when the recording apparatus 1 according to the embodiment is used to cut the medium M with the cutter 24. In the medium cutting method described in the claims, the first operation includes step S120 as a first conveyance step of conveying the medium M by a predetermined amount in the conveyance direction A to a position where the leading end of the medium M travels beyond the frictional support member 40. The medium cutting method further includes step S130 as a second conveyance step of conveying the medium M in the direction opposite the conveyance direction A until the cutting position of the medium M reaches the cutting position CP, where the cutting is performed by the cutter 24. The medium cutting method still further includes step S150 as a cutting step of cutting the medium M.

Executing the medium cutting method described above allows cutting the medium M while supporting the medium M with the frictional support member 40, and can prevent the cutting operation from being performed in the state in which the leading end Ma of the medium M is caught by the frictional support member 40 so that the medium M bends. Executing the medium cutting method described above therefore allows cutting the medium M with high precision, and avoiding a trouble at the time of cutting the medium.

In the medium cutting method described above, the first operation including steps S120 and S130 and the second operation including step S140 can be selectively performed. In other words, the recording apparatus 1 according to the present embodiment can cause the conveyer 29 and the cutter 24 to selectively perform the first operation and the second operation different from the first operation under the control of the controller 20. The controller 20 can cause the conveyer 29 and the cutter 24 to perform the first operation when the length of the cut medium Me along the conveyance direction A, which is cut off by the cutter 24, falls within a predetermined range described later.

Executing the medium cutting method described above allows suppressing a decrease in throughput due to performing the first operation, and therefore allows suppressing a decrease in productivity when the length of the cut medium Me along the conveyance direction A does not fall within the predetermined range, so that the medium M can be cut with high precision and a trouble at the time of cutting the medium can be avoided without performing the first operation. In other words, performing the conveyance control only in a specific case in which a trouble at the time of cutting the medium or the like is likely to occur allows preventing throughput from decreasing and suppressing a decrease in productivity.

Specifically, in step S140 contained in the second operation, the medium M is conveyed in the conveyance direction A until the cutting position of the medium M reaches the cutting position CP, where the cutting is performed by the cutter 24, under the control of the controller 20. Thereafter, in step S150, the medium M is cut without being conveyed in the direction opposite the conveyance direction A. When the length of the cut medium Me along the conveyance direction A does not fall within the predetermined range described later, the controller 20 can cause the conveyer 29 and the cutter 24 to perform the second operation. As described before, since the second operation can be performed in a shorter period than the first operation, executing the medium cutting method described above allows suppressing a decrease in throughput due to performing the first operation, and therefore allows suppressing a decrease in productivity when the medium M can be cut with high precision and a trouble at the time of cutting the medium can be avoided without performing the first operation.

The predetermined range of the length of the cut medium Me along the conveyance direction A will now be described. The recording apparatus 1 according to the present embodiment can cause the conveyer 29 and the cutter 24 to perform the first operation when the length of the cut medium Me along the conveyance direction A that corresponds to a distance L1 shown in FIG. 5 from the cutting position CP, where the cutting is performed by the cutter 24, to the leading end Ma of the medium M is longer than or equal to 99 mm but shorter than or equal to 128 mm, and can cause the conveyer 29 and the cutter 24 to perform the second operation when the length is shorter than 99 mm or longer than 128 mm. The reason for this is that the length from the cutting position CP, where the cutting is performed by the cutter 24, to the position where the leading end Ma of the conveyed medium M comes into contact with the frictional support member 40 is 99 mm, and that an expected length of 29 mm, which results from a curl of the medium M, added to the length of 99 mm makes 128 mm.

As shown in FIG. 1 and other figures, the recording apparatus 1 according to the present embodiment includes, as the frictional support member 40, four frictional support members 40A, 40B, 40C, and 40D sequentially arranged from the side facing the negative end in the X direction toward the side facing the positive end in the X direction. The frictional support members 40A, 40B, 40C, and 40D all have the same configuration, and may each have a configuration capable of supporting a portion of the rear surface of the medium M being cut by the cutter 24 while applying friction to the portion. Employing the configuration in which the frictional support members 40A, 40B, 40C, and 40D support portions of the rear surface of the medium M being cut by the cutter 24 while applying friction to the portions as described above can preferably reduce a risk that the cut medium Me on the side where the cutter 24 starts cutting the medium M hangs down due to gravity when the medium M is being cut, so that the medium M being cut bends or otherwise deforms.

The arrangement and the number of the frictional support members 40A, 40B, 40C, and 40D are not limited to a specific arrangement and number. However, in a configuration in which the cutter 24 moves from one side (−X-direction side) toward the other side (+X-direction side) in the width direction B, it is preferable that at least one of the frictional support members 40A, 40B, 40C, and 40D is provided on the one side (−X-direction side) at the guide 16 as the frictional support member 40A in the present embodiment. The reason for this is that the configuration described above can particularly preferably reduce the risk that the cut medium Me on the side where the cutter 24 starts cutting the medium M hangs down due to gravity when the medium M is being cut, so that the medium M being cut bends or otherwise deforms. The phrase " a frictional support member is provided on one side" means that the frictional support member only needs to be provided on one side of the center, in the width direction B, of the path along which the medium M is conveyed.

The present disclosure is not limited to the embodiment described above and can be realized in various configurations without departing from the intent of the present disclosure. To solve the problems described above partially or entirely, or to achieve the advantages described above partially or entirely, the technical features in the embodiment that correspond to the technical features in the respective aspects described in SUMMARY of the present disclosure can be replaced or combined as appropriate. Moreover, any of the technical features can be deleted as appropriate unless described as essential technical feature in the present specification.

What is claimed is:

1. A recording apparatus comprising:
a medium support configured to support a medium;
a conveyer configured to convey the medium in a conveyance direction;
a head configured to discharge droplets onto the medium supported by the medium support;
a guide provided at a position downstream from the medium support and configured to guide the medium having the droplets discharged thereon from the medium support in the conveyance direction;
a cutting unit provided at a position downstream from the head and configured to cut the medium conveyed in the conveyance direction while moving in a width direction that intersects with the conveyance direction;
a frictional support member provided at the guide, configured with an elastic member, and configured to support the medium by applying friction onto a rear surface of the medium opposite a surface that receives the droplets; and
a controller configured to control the conveyer and the cutting unit,
wherein when the cutting unit cuts the medium, the controller is configured to cause the conveyer and the cutting unit to perform a first operation of
conveying the medium by a predetermined amount in the conveyance direction to a position where a leading end of the medium travels beyond the frictional support member,
conveying the medium in a direction opposite the conveyance direction until a cutting position of the medium reaches the cutting unit, and
cutting the medium.

2. The recording apparatus according to claim 1, wherein
the controller is configured to cause
the conveyer and the cutting unit to selectively perform the first operation and a second operation different from the first operation, and
the conveyer and the cutting unit to perform the first operation when a length, along the conveyance direction, of a cut medium cut off by the cutting unit falls within a predetermined range.

3. The recording apparatus according to claim 2, wherein
the second operation causes the medium to be conveyed in the conveyance direction until the cutting position of the medium reaches the cutting unit, and causes the medium to be cut without conveying the medium in the direction opposite the conveyance direction, and
the controller is configured to cause the conveyer and the cutting unit to perform the second operation when the length of the cut medium along the conveyance direction does not fall within the predetermined range.

4. The recording apparatus according to claim 1, wherein
the frictional support member is configured to support a portion of the rear surface of the medium being cut by the cutting unit by applying friction onto the portion.

5. The recording apparatus according to claim 4, wherein
the cutting unit moves from one side toward another side in the width direction, and
the frictional support member is provided on the one side at the guide.

6. A medium cutting method used by a recording apparatus including
a medium support configured to support a medium,
a conveyer configured to convey the medium in a conveyance direction,
a head configured to discharge droplets onto the medium supported by the medium support,
a guide provided at a position downstream from the medium support and configured to guide the medium having the droplets discharged thereon from the medium support in the conveyance direction,
a cutting unit provided at a position downstream from the head and configured to cut the medium conveyed in the conveyance direction while moving in a width direction that intersects with the conveyance direction, and
a frictional support member provided at the guide, configured with an elastic member, and configured to support the medium by applying friction onto a rear surface of the medium opposite a surface that receives the droplets,
the method comprising
performing a first operation when the cutting unit cuts the medium,
the first operation including
a first conveyance step of conveying the medium by a predetermined amount in the conveyance direction to a position where a leading end of the medium travels beyond the frictional support member,
a second conveyance step of conveying the medium in a direction opposite the conveyance direction until a cutting position of the medium reaches the cutting unit, and
a cutting step of cutting the medium.

7. The medium cutting method according to claim 6, wherein
the recording apparatus is configured to
selectively perform the first operation and a second operation different from the first operation when the cutting unit cuts the medium, and
perform the first operation when a length, along the conveyance direction, of a cut medium cut off by the cutting unit falls within a predetermined range.

8. The medium cutting method according to claim 7, wherein
the second operation causes the medium to be conveyed in the conveyance direction until the cutting position of the medium reaches the cutting unit, and causes the medium to be cut without conveying the medium in the direction opposite the conveyance direction, and
the second operation is performed when the length of the cut medium along the conveyance direction does not fall within the predetermined range.

9. The medium cutting method according to claim 6, wherein
the frictional support member is configured to support a portion of the rear surface of the medium being cut by the cutting unit by applying friction onto the portion.

10. The medium cutting method according to claim 9, wherein
in the cutting step, the cutting unit is moved from one side toward another side in the width direction, and
the frictional support member is provided on the one side at the guide.

11. A medium cutting apparatus comprising:
a medium support configured to support a medium;
a conveyer configured to convey the medium in a conveyance direction;
a guide provided at a position downstream from the medium support and configured to guide the medium from the medium support in the conveyance direction;
a cutting unit provided at a position downstream from the medium support and configured to cut the medium conveyed in the conveyance direction while moving in a width direction that intersects with the conveyance direction;
a frictional support member provided at the guide, configured with an elastic member, and configured to support the medium by applying friction onto a rear surface of the medium at which the medium is supported; and
a controller configured to control the conveyer and the cutting unit,
wherein when the cutting unit cuts the medium, the controller is configured to cause the conveyer and the cutting unit to perform a first operation of
conveying the medium by a predetermined amount in the conveyance direction to a position where a leading end of the medium travels beyond the frictional support member,
conveying the medium in a direction opposite the conveyance direction until a cutting position of the medium reaches the cutting unit, and
cutting the medium.

12. The medium cutting apparatus according to claim 11, wherein
the controller is configured to cause
the conveyer and the cutting unit to selectively perform the first operation and a second operation different from the first operation, and
the conveyer and the cutting unit to perform the first operation when a length, along the conveyance direction, of a cut medium cut off by the cutting unit falls within a predetermined range.

13. The medium cutting apparatus according to claim 12, wherein
the second operation causes the medium to be conveyed in the conveyance direction until the cutting position of the medium reaches the cutting unit, and causes the medium to be cut without conveying the medium in the direction opposite the conveyance direction, and
the controller is configured to cause the conveyer and the cutting unit to perform the second operation when the length of the cut medium along the conveyance direction does not fall within the predetermined range.

14. The medium cutting apparatus according to claim 11, wherein
the frictional support member is configured to support a portion of the rear surface of the medium being cut by the cutting unit by applying friction onto the portion.

15. The medium cutting apparatus according to claim 14, wherein
the cutting unit moves from one side toward another side in the width direction, and
the frictional support member is provided on the one side at the guide.
